(19) United States
(12) Patent Application Publication
(10) Pub. No.: US 2004/0088658 A1
(43) Pub. Date: May 6, 2004

(54) Method of designing semiconductor device

(76) Inventor: Hiroyasu Minda, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/331,973

(22) Filed: Dec. 30, 2002

(30) Foreign Application Priority Data
Oct. 30, 2002 (JP) 315460/2002

(51) Int. Cl. G06F 17/50

(52) U.S. Cl. 716/1

(57) ABSTRACT

In a mixed-loaded type semiconductor device including a plurality of MOS transistors having gate insulating films different in thickness, the antenna standard for the MOS transistor having the gate insulating film with a thickness equal to or smaller than a predetermined thickness is relaxed compared with that for the MOS transistor having the gate insulating film with a thickness larger than the predetermined thickness. In particular, the antenna standard for the MOS transistor having the gate insulating film with a thickness equal to or smaller than 2.6 nm allowing the tunneling of the electric charges to occur is relaxed compared with that for the MOS transistor having the gate insulating film with a thickness larger than 2.6 nm.

### BACKGROUND OF THE INVENTION

1. Field of the Invention

The present invention relates to a method of designing a semiconductor device including semiconductor elements each having a gate insulating film. In particular, the invention relates to a method of designing a semiconductor device in which a plurality of semiconductor elements having different gate insulating films are formed integrally with one another on the same substrate.

2. Description of a Related Art

In semiconductor elements each having a gate insulating film such as MOS transistors, the degradation of reliability of gate insulating films, the degradation of characteristics of gate insulating films, or the breakdown of gate insulating films in the process for manufacturing those becomes a problem. For example, in a semiconductor device including MOS transistors as semiconductor elements, after a gate insulating film made of a silicon oxide film or the like is formed on a semiconductor substrate, and a gate electrode made of polysilicon, aluminum, or the like is formed on the substrate body to form a MOS transistor, an interlayer insulating film is formed such that the MOS transistor is covered therewith, contact plugs are formed through the interlayer insulating film so as to contact the gate electrode, upper layer wiring is formed on the interlayer insulating film so as to contact the contact plugs, and via holes (through holes) are formed through the interlayer insulating film so as to extend to the wiring. While in the series of processes, during the formation of the gate electrode, the contact plugs, the wiring, the via holes, and the like, the etching using the plasma such as the reactive ion etching for formation of desired patterns therefor is carried out, the electric charges are accumulated in the gate electrode, the contact plugs, the wiring, the via holes, and the like as the materials to be etched due to the plasma generated by the etching to generate the so-called charge-up. In addition, the charge-up is also generated when the interlayer insulating film is formed by utilizing the plasma CVD or the like, when the via holes are bored, and so forth. Furthermore, if the processing under the condition on which the electric charges are generated is concerned, in the case as well of the wet processing for peeling and the like, the charge-up maybe generated in some cases. Then, the electric charges thus charged are transmitted from the upper layer wiring, the via hole stand the like to the gate electrode to be accumulated therein and then are discharged to the semiconductor substrate through the gate insulating film. This discharge causes the degradation of reliability of the gate insulating films, the degradation of characteristics of the gate insulating films, or the breakdown of the gate insulating films.

As the primary factor of the damage of a device due to such charge-up, the increase in aspect ratio and antenna ratio is mentioned in Japanese patent laid open 2000-331990. Here, the aspect ratio means the ratio of an etching height to an opening width of a photo resist film in an opening pattern during the plasma etching (etching height/opening width). In addition, the antenna ratio means the ratio of an area of an antenna electrode to an area of a gate insulating film (an area of an antenna electrode/an area of a gate insulating film). Then, the antenna electrode means a gate electrode, a via hole extending thereto, a upper wiring or the like and in particular, a conductive member which is etched by the plasma. When seeing the antenna ratio of them, a quantity of electric charges charged up during the etching of the antenna electrode such as the gate electrode, the via hole, the upper layer wiring, and the like is in proportion to a surface area of the antenna electrode including the via holes and the upper layer wiring which are exposed to the plasma ambient atmosphere. Then, since the charged up electric charges are transmitted concentratedly to the gate insulating film, the gate insulating film in unit area is charged with the electric charges corresponding to the above-mentioned antenna ratio. For this reason, the degradation of reliability of the gate insulating films, the degradation of characteristics of the gate insulating films or the breakdown of the gate insulating films is more readily generated as the antenna ratio of the MOS transistor becomes larger. Thus, if of the design standards for the design and the manufacture of a semiconductor device, the standard for the antenna ratio (hereinafter, referred to as “the antenna standard” in this specification) is severely set to reduce the antenna ratio, then it is possible to prevent the degradation of reliability of the gate insulating films, the degradation of characteristics of the gate insulating films or the breakdown of the gate insulating films due to the above-mentioned charge-up.

In a semiconductor element including a gate insulating film, in particular, in a MOS transistor, it is known that the breakdown voltage of a gate insulating film is further increased as the gate insulating film is thicker. For a semiconductor device having a gate insulating film with equal to or larger than 10 nm thickness used in a 5V-CMOS transistor or the like, no antenna standard was provided. However, agate insulating film is forced to be thinned along with the scale down (shrink) of a MOS transistor due to the promotion of high integration, the promotion of high performance and the promotion of low voltage operation in a semiconductor device. For this reason, as described above, the antenna standard is severely set in order to prevent the degradation of reliability of the gate insulating films, the degradation of characteristics of the gate insulating films or the breakdown of the gate insulating films in MOS transistors. However, this leads to that the design of via holes and upper layer wiring in a semiconductor device suffers the restriction. Thus, there is encountered the problem in that the degree of freedom of the design is reduced. In particular, as in recent years, if the high integration, the high performance and the low voltage for a semiconductor devices have been promoted to reduce wiring widths, to increase the wiring density, to promote the multilayer wiring and to increase an area of a semiconductor device, then the total wiring length will be increased and also the number of via holes connected to the wiring will be increased. This results in the increase in area of the antenna electrode. On the other hand, since the antenna ratio is easy to be remarkably increased due to the decrease in area of the gate electrode, or the like due to the scale down of MOS transistors, the degree of freedom of the design is decreased more and more.

### SUMMARY OF THE INVENTION

In MOS transistors, as described above, the breakdown voltage of a gate insulating film is further increased as the gate insulating film is thicker. On the other hand, it is reported that when a gate insulating film is made thinner, the tunneling effect occurs which allows the electric charges to pass through the gate insulating film to reach up to a semiconductor substrate, and hence the gate insulating film is hardly broken down. For example, in an article of “Reliability of Thin Oxide under Plasma Charging Caused by Antenna Topography—Depending Electron Shading Effect”, IEEE, IEDM 97-41, 17.3, 1-4, 1997, as shown in FIG. 16, there is reported the correlation between a thickness of a gate insulating film and a conforming article rate of the gate insulating films during the plasma etching for MOS transistors having the antenna ratios of 5 K and 24 K, respectively. From this report, it is understood that thickening the gate insulating film suppresses the breakdown, while even when the gate insulating film is thinned, the breakdown is suppressed by the tunneling of the electric charges.

This report simply shows the relationship between a thickness of a gate insulating film and the antenna ratio in MOS transistors, and thus at what antenna ratio a semiconductor device loaded with a plurality of MOS transistors having different gate insulating films is preferably designed and manufactured is not mentioned. For this reason, when a mixed-loaded type semiconductor device is manufactured, the antenna ratio in the semiconductor device is compelled to be set with the standard for a MOS transistor having a gate insulating film for which the antenna ratio is severely set as reference to design and manufacture the semiconductor device concerned. Thus, this results in that the degree of freedom of the design and the manufacture of a semiconductor device is low to make it difficult to design and manufacture the same as described above.

Then, the present invention may provide a mixed loaded type semiconductor device including a plurality of semiconductor elements having gate insulating films which are different in thickness, wherein the semiconductor elements are formed so as to conform the different antenna standards, respectively. That is to say, the antenna standard for the semiconductor element having a gate insulating film with a thickness equal to or smaller than a predetermined thickness is relaxed as compared with the antenna standard for a semiconductor element having a gate insulating film with a thickness larger than the predetermined thickness. In particular, the antenna standard for a semiconductor element having a gate insulating film with a thickness equal to or smaller than a thickness allowing the tunneling of the electric charges to occur is relaxed as compared with the antenna standard for a semiconductor element having a gate insulating film with a thickness larger than the thickness allowing the tunneling of the electric charges to occur. Note that, while the antenna standard in the present invention means the antenna ratio as the subject, it may contain the aspect ratio in an antenna. Also, the antenna ratio and the aspect ratio have the same definitions as those references. In such a manner, formation of a gate insulating film with a thickness smaller than a thickness allowing the tunneling of the electric charges to occur allows the antenna ratio in the semiconductor element to be increased, which makes it possible to relax the design standard to enhance the degree of freedom of the design and the manufacture of a semiconductor device.

More specifically, according to the experiments made by the present inventor, it was confirmed that the remarkable tunneling effect when a gate insulating film is made of a silicon oxide film appears when the thickness of the gate insulating film is 2.6 nm. Also, it was confirmed that it the gate insulating film has a thickness smaller than that thickness, the effect of preventing the degradation of reliability of the gate insulating films, the degradation of characteristics of the gate insulating films or the breakdown of the gate insulating films is enhanced. Then, in the present invention, when a gate insulating film is made of a silicon oxide film, the antenna ratio of a semiconductor element having a gate insulating film with a thickness equal to or smaller than 2.6 nm is made larger than that of a semiconductor element having a gate insulating film with a thickness larger than 2.6 nm, thereby attaining the above-mentioned object of the present invention. In addition, in this case, it is also confirmed that with respect to a semiconductor element having a gate insulating film with a thickness larger than 2.6 nm, if a poly antenna ratio is set equal to or smaller than 100, a contact antenna ratio is set equal to or smaller than 10, a via antenna ratio is seL equal to or smaller than 20, and a wiring antenna ratio is set equal to or a smaller than 5,000, then it is possible to prevent the degradation of reliability of the gate insulating films, the degradation of characteristics of the gate insulating films or the breakdown of the gate insulating films in the semiconductor element concerned. Here, the poly antenna ratio means the antenna ratio which is calculated from an area of a gate electrode made of polysilicon, the contact ratio means the antenna ratio which is calculated from an area of a contact hole through which the connection is made to a semiconductor element, the via antenna ratio means the antenna ratio which is calculated from an area of a via hole through which the connection is made between a semiconductor element and wiring, the wiring antenna ratio means the antenna ratio which is calculated from an area of wiring, and so forth. In particular, the wiring antenna ratio is calculated from an area which is obtained by adding areas of all of the wiring from the wiring layer of a lowermost layer to the wiring layer of a uppermost layer. Likewise, the via antenna ratio is also calculated from an area which is obtained by adding areas of all of the via holes containing the via holes in the lowermost layer to the via holes in the uppermost layer. As a result, it is possible to obtain a semiconductor device which is free from the degradation of reliability of the gate insulating films, the degradation of characteristics of the gate insulating films or the breakdown of the gate insulating films of a transistor in all of the mixedly loaded semiconductor elements.

Furthermore, in the present invention, when the antenna electrode portion is common between a semiconductor element having a gate insulating film with a thickness equal to or smaller than a predetermined thickness and a semiconductor element having a gate insulating film with a thickness larger than the predetermined thickness, a semiconductor device is formed in accordance with the antenna standard for the semiconductor element having a gate insulating film with a thickness larger than the predetermined thickness. This makes it possible to prevent the degradation of reliability of the gate insulating films, the degradation of characteristics of the gate insulating films or the breakdown of the gate insulating films in a semiconductor element conforming to the generous antenna standard due to the discharge of the charged-up electric charges in a portion common to the antenna electrodes.

In addition, the present invention may provide a method of manufacturing a semiconductor device, the method including the steps of: manufacturing a semiconductor element having a gate insulating film with a thickness larger than a predetermined thickness in accordance with a first antenna standard; and manufacturing a semiconductor element having a gate insulating film with a thickness smaller than the predetermined thickness in accordance with a second antenna standard which is relaxed as compared with the first antenna standard. Since at least a part of semiconductor elements of a semiconductor device can be designed and manufactured in accordance with the more generous second antenna standard, it is possible to promote easiness of the design and the manufacture of the whole semiconductor device.

In addition, the charge-up as described above is caused by the plasma and the like and the positive electric charges are predominant therein. Since the positive electric charges are charged up in the gate electrode portion, easiness of generation of the degradation of reliability of the gate insulating films, the degradation of characteristics of the gate insulating films or the breakdown of the gate insulating films differs between an NMOS (N-channel MOS) transistor and a PMOS (P-channel MOS) transistor. More specifically, in an NMOS transistor, the positive electric charges called the positive holes are present just under a gate insulating film. Likewise, the electrons are present in a PMOS transistor and hence the negative electric charges are present therein. For this reason, the different electric fields are applied to the NMOS transistor and the PMOS transistor through the gate insulating film, respectively, and hence the degradation of reliability of the gate insulating films, the degradation of characteristics of the gate insulating films or the breakdown of the gate insulating films becomes remarkable in the PMOS transistor. Thus, the different antenna standards are provided for the NMOS transistor and the PMOS transistor, respectively, to make the antenna standard for the NMOS transistor more generous than that for the PMOS transistor, thereby further increasing the degree of freedom of the design.

Now, while the above-mentioned NMOS transistor and PMOS transistor are mainly formed on a silicon substrate, it is readily presumed that the substrate for a semiconductor device is not intended to be limited to an N type silicon substrate, a P type silicon substrate, an SOI substrate, or the like This reason is that since the conductivity types of the NMOS transistor and the PMOS transistor are determined by materials to be implanted thereinto, those do not depend on kinds of substrates.

In addition, since the charge-up is due to the discharge of the positive electric charges, as a method of protecting a gate insulating film of a semiconductor element, the positive electric charges can be set free through a PN junction type diode connected thereto. More specifically, it is taken into consideration that during connection of first metal wiring portion, the connection of the diode is made on a P type diffusion layer concurrently with the connection to a gate electrode, thereby allowing the positive electric charges to be set free towards the substrate side through the PN junction type diode. Thus, the connection of the PN junction type diode makes it possible to relax the antenna standard to realize the design of a semiconductor device having a larger antenna ratio without causing the degradation of reliability of the gate insulating films, the degradation of characteristics of the gate insulating films or the breakdown of the gate insulating films. However, while the connection of a diode element for prevention of the charge-up is effective, connecting a number of diode elements more than is necessary becomes the primary factor of impeding scale down of a semiconductor device. Thus, it is to be understood that diodes each having a small area are desirably formed to prevent the charge-up.

### BRIEF DESCRIPTION OF THE DRAWINGS

The above and other objects as well as advantages of the present invention will become clear by the following description of the preferred embodiments of the present invention with reference to the accompanying drawings, wherein:

FIG. 1 is a plan view showing structure of an embodiment of a semiconductor device according to the present invention;

FIG. 2 is a schematic enlarged cross sectional view taken generally on line A-A of FIG. 1;

FIGS. 3(a) to 3(d) are cross sectional views showing a part of steps of a manufacturing process of a semiconductor device structure shown in FIG. 2;

FIGS. 4(a) and 4(b) are respectively a graphical representation useful in explaining the correlation between an antenna ratio of a poly antenna and a conforming article rate with a thickness of a gate insulating film as a parameter and a graphical representation useful in explaining the correlation between a thickness of a gate insulating film and a conforming article rate with an antenna ratio of a poly antenna as a parameter;

FIGS. 5(a) and 5(b) are respectively a graphical representation useful in explaining the correlation between an antenna ratio of a contact antenna and a conforming article rate with a thickness of a gate insulating film as a parameter and a graphical representation useful in explaining the correlation between a thickness of a gate insulating film and a conforming article rate with an antenna ratio of a poly antenna as a parameter;

FIGS. 6(a) and 6(b) are respectively a graphical representation useful in explaining the correlation between an antenna ratio of a via antenna and a conforming article rate with a thickness of a gate insulating film as a parameter and a graphical representation useful in explaining the correlation between a thickness of a gate insulating film and a conforming article rate with an antenna ratio of a poly antenna as a parameter;

FIGS. 7(a) and 7(b) are respectively a graphical representation useful in explaining the correlation between an antenna ratio of a wiring antenna and a conforming article rate with a thickness of a gate insulating film as a parameter and a graphical representation useful in explaining the correlation between a thickness of a gate insulating film and a conforming article rate with an antenna ratio of a poly antenna as a parameter;

FIGS. 8(a) and 8(b) are respectively a graphical representation useful in explaining the correlation between an antenna ratio of a poly antenna and a conforming article rate with a thickness of a gate insulating film as a parameter and a graphical representation useful in explaining the correlation between a thickness of a gate insulating film and a conforming article rate with an antenna ratio of a poly antenna as a parameter in NMOS transistors;

FIGS. 9(a) and 9(b) are respectively a graphical representation useful in explaining the correlation between an antenna ratio of a contact antenna and a conforming article rate with a thickness of a gate insulating film as a parameter and a graphical representation useful in explaining the correlation between a thickness of a gate insulating film and a conforming article rate with an antenna ratio of a contact antenna as a parameter in NMOS transistors;

FIGS. 10(a) and 10(b) are respectively a graphical representation useful in explaining the correlation between an antenna ratio of a via antenna and a conforming article rate with a thickness of a gate insulating film as a parameter and a graphical representation useful in explaining the correlation between a thickness of a gate insulating film and a conforming article rate with an antenna ratio of a via antenna as a parameter in NMOS transistors;

FIGS. 11(a) and 11(b) are respectively a graphical representation useful in explaining the correlation between an antenna ratio of a wiring antenna and a conforming article rate with a thickness of a gate insulating film as a parameter and a graphical representation useful in explaining the correlation between a thickness of a gate insulating film and a conforming article rate with an antenna ratio of a wiring antenna as a parameter in NMOS transistors;

FIGS. 12(a) and 12(b) are respectively a graphical representation useful in explaining the correlation between an antenna ratio of a via antenna and a conforming article rate with a thickness of a gate insulating film as a parameter and a graphical representation useful in explaining the correlation between a thickness of a gate insulating film and a conforming article rate with an antenna ratio of a via antenna as a parameter in PMOS transistors;

FIGS. 13(a) and 13(b) are respectively a graphical representation useful in explaining the correlation between an antenna ratio of a wiring antenna and a conforming article rate with a thickness of a gate insulating film as a parameter and a graphical representation useful in explaining the correlation between a thickness of a gate insulating film and a conforming article rate with an antenna ratio of a wiring antenna as a parameter in PMOS transistors;

FIG. 14 is a cross sectional view showing structure of a part of a PMOS transistor in which a PN junction type diode is formed;

FIGS. 15(a) and 15(b) are respectively a graphical representation useful in explaining the correlation between a diode area (diode size) and a conforming article rate with a size of a wiring antenna and a thickness of a gate oxide film as parameters and a graphical representation useful in explaining the correlation between a diode area and a conforming article rate with a size of a via antenna and a thickness of a gate oxide film as parameters in MOS transistors; and

FIG. 16is a graphical representation useful in explaining the correlation between a thickness of a gate insulating film and a conforming article rate with an antenna ratio as a parameter which is reported.

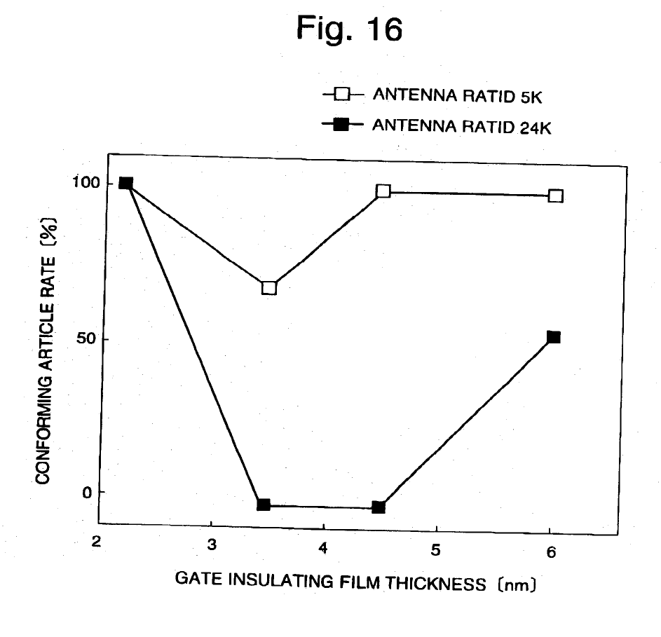

### DETAILED DESCRIPTION OF THE PREFERRED EMBODIMENTS

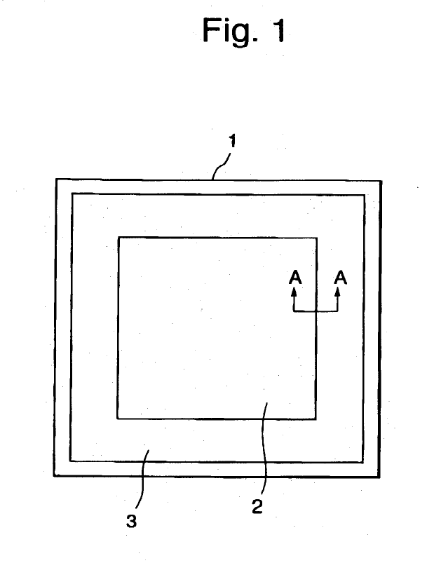

FIG. 1 is a plan view schematically showing structure of one example of a chip of an embodiment in which the present invention is applied to a semiconductor device having MOS transistors as elements. In the figure, an internal circuit 2 in which a large number of minute MOS transistors having small gate size and constituting a memory circuit, a logic circuit or the like are formed is arranged in a center area of a chip 1. In addition, a peripheral circuit 3 in which MOS transistors having large gate size and constituting an I/O circuit or the like are formed is arranged in a peripheral area of the chip 1. Then, as will be described below, the desired electrical connection is carried out through upper layer wiring having lamination structure, for the MOS transistors of the internal circuit 2 and the peripheral circuit 3. Now, the peripheral circuit is also called an I/O element or an I/O buffer in some cases, and its arrangement is not limited to only the peripheral portion as shown in FIG. 1. Hence, the peripheral circuit is arranged without regard to the actual arrangement of a semiconductor device.

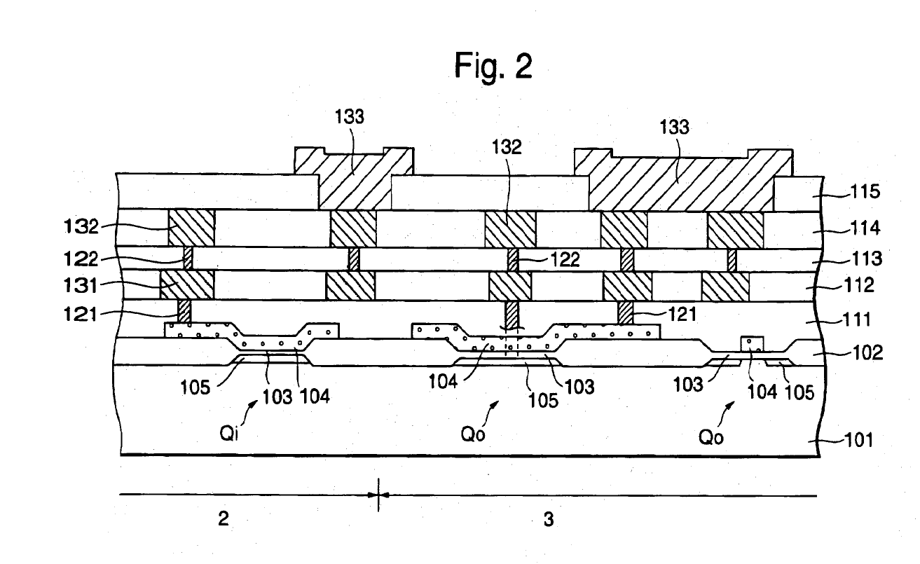

FIG. 2 is a schematic cross sectional view taken generally on line A-A of FIG. 1 showing the chip 1. An isolation insulating film 102 is formed on the surface of a silicon substrate 101 in accordance with the general formation method so that a minute MOS transistor Qi of the internal circuit 2 is isolated from MOS transistors. Qo of the peripheral circuit 3 through the isolation insulating film 102. Each of the MOS transistors Qi and Qo is constituted by a gate insulating film 103 which is made of a silicon oxide film and which is formed above the surface of a silicon substrate 101, a gate electrode 104 which is made of polysilicon and which is formed on the gate insulating film 103, and a source/drain region 105 which is formed by introducing impurities into the silicon substrate 101. In addition, the above-mentioned MOS transistors Qi and Qo are covered with a first interlayer insulating film 111, and also contact plugs 121 provided through the first interlayer insulating film 111 are electrically connected to the gate electrode 104 and the source/drain region 105. Further, a second interlayer insulating film 112 is formed on the first interlayer insulating film 111, and a first upper layer wiring 131 which is made of metal containing aluminum, gold, silver, copper, or the like as the main constituent and which has a desired pattern having the damascene structure is formed on the second interlayer insulating film 112 to be electrically connected to the gate electrode 104 and the source/drain region 105 through the contact plugs 121. Furthermore, a third interlayer insulating film 113 is formed on the second interlayer insulating film 112 and a first via hole 122 for connection to the first upper layer wiring 131 which has the damascene structure and which is formed through the second interlayer insulating film 112 is formed through the third interlayer insulating film 113. A fourth interlayer insulating film 114 is laminated on the third interlayer insulating film 113 and second upper layer wiring 132 having the damascene structure is formed so as to be electrically connected to the first via hole 122 which is formed through the third interlayer insulating film 113 to be electrically connected to the gate electrode 104 or the source/drain region 105. An uppermost layer insulating film 115 is formed thereon and an aluminum pad 133 connected to the second upper layer wiring 132 is formed so as to be filled in an opening formed through the uppermost layer insulating film 115.

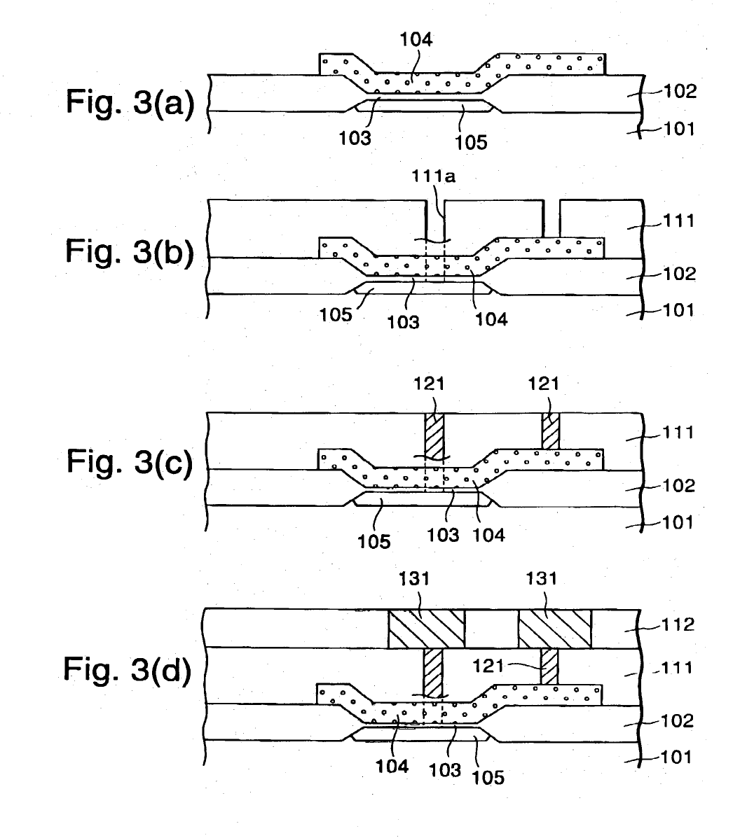

With respect to a method of manufacturing this semiconductor device, for example, as shown in FIG. 3(a), after the surface of the silicon substrate 101 is selectively oxidized to form isolation insulating films 102 each made of a thick silicon oxide film, the surface of active regions which are partitioned by those isolation insulating films 102 is oxidized to form gate oxide films 103 each made of a thin silicon oxide film. Next, after a polysilicon film is grown over the whole surface, the polysilicon film concerned is selectively etched away by utilizing the plasma etching method using the photolithography technique. Then, after the plasma processing is carried out in the oxygen or H₂—N₂ ambient atmosphere, the deposition and photo resist after the etching are wet-peeled off to form gate wiring (not shown) which is electrically connected to the gate electrode 104 and the like. During the plasma etching for formation of the gate electrode 104 and the gate wiring, the electric charges are charged up in the gate electrode 104. Next, impurities are introduced into the active regions of the silicon substrate 101 in the self-aligned manner utilizing the gate electrode 104 as a mask to form the source/drain regions 105, thereby manufacturing the MOS transistors.

Next, as shown in FIG. 3(b), after the first interlayer insulating film 111 is formed over the whole surface by utilizing the plasma CVD method, the leveling maybe carried out as required by utilizing reflow by the heat treatment or the CMP (chemical and mechanical polishing) method. Thereafter, after openings 111a are formed in the positions where the contact plugs are to be formed on the gate electrode 104 and the source/drain region 105 by utilizing the plasma etching method utilizing the Photolithography technique, and the plasma processing is carried out in the oxygen or H₂—N₂ ambient atmosphere in order to remove the photo resist film, the wet-peeling is carried out. During the plasma CVD as well, the electric charges are charged up in the exposed gate electrode 104, and during the subsequent plasma etching as well, the electric charges are charged up from the openings 111a for the contact plugs to the gate electrode 104. Next, as shown in FIG. 3(c) g a metal film is formed by utilizing the plasma CVD method, the reactive sputtering method, the PVD method, or the like so as to have a thickness enough to be filled in the openings 111a for the contact plugs, and then the metal film is left only in the openings 111a by utilizing the etching from the surface side or the CMP method to form the contact plugs 121. During this etching or the CMP process as well, the electric charges are also charged up in the contact plugs 121 to be transmitted to the gate electrode 104 to thereby be charged up therein.

Next, as shown in FIG. 3(d), after the second interlayer insulating film 112 is formed by utilizing the CVD method, openings are formed therethrough in positions where the first upper layer wiring is to be formed by utilizing the plasma etching method utilizing the photolithography technique. Then, after the plasma processing is carried out in the oxygen or H₂—N₂ ambient atmosphere in order to remove the photo resist film, the wet-peeling is carried out. At this time, likewise, the electric charges are charged up in the gate electrodes 104 through the contact plugs 121. Then, similarly to the case of formation of the contact plugs 121, a metal film is formed so as to have a thickness enough to be tilled in the openings, and then it is left only in the openings by carrying out the etching or the like from the surface side to form the first upper layer wiring 131. While this process is made by utilizing the general trench wiring formation technique, it may also be made by utilizing the wiring processing method or the like utilizing the RIE method. Hereinbelow, as shown in FIG. 2, likewise, the third interlayer insulating film 113, the first via holes 122, the fourth interlayer insulating film 114 and the second upper layer wiring 132 are respectively formed. Furthermore, after the uppermost interlayer insulating film 115 is formed and the openings are formed through the second upper layer wiring 132 in the positions to be exposed, the aluminum film is formed over the whole surface. Then, the aluminum film is selectively etched away to form the aluminum pads 133. Note that, while not illustrated in FIG. 2 and FIGS. 3(a) to 3(d), the PMOS transistors and the NMOS transistors are assumed to be formed in the internal circuit 2 and the peripheral circuit 3, respectively. It is to be understood that for the formation of these MOS transistors, the impurities of different conductivity types are introduced into the silicon substrate in the regions in which the source/drain regions are to be formed, respectively.

In the semiconductor device, as shown in FIG. 2, which is manufactured in such a manner, as described above, the plasma etching process when the gate electrodes 104 are formed on the gate insulating films 103, the plasma CVD process for formation of the first interlayer insulating film 111, the plasma CVD method or the reactive sputtering method for formation of the contact plugs 121, the PVD method, the plasma etching method and the like are utilized, and on and after these processes, during the formation as well of the first via holes 122, the first upper layer wiring 131, and the aluminum pads 133, the various kinds of plasma processings are carried out. Thus, the charge-up is generated in the gate electrodes, the via holes and the upper layer wiring all of which are in the state of being exposed during execution of these processings. In addition, the charge-up may also be generated in the wet processing such as the wet etching, the CMP, the cleaning, and the like in some cases. For this reason, the fact that there is the possibility that the degradation of reliability of the gate insulating films, the degradation of characteristics of the gate insulating films or the breakdown of the gate insulating films may occur in the individual processes is as we had mentioned above.

Then, in the present embodiment, in each of the minute MOS transistors Qi of the internal circuit 2, the gate length and b the gate width of the gate electrode 104 are scaled down as compared with the ate length and the gate width of the gate electrode of each of the MOS transistors Qo of the peripheral circuit 3, and also the thickness of the gate insulating film 103 of the former is decreased as compared with the latter. In the present embodiment, the gate insulating film 103 of each of the minute MOS transistors Qi of the internal circuit has a thickness of equal to or smaller than 2.6 nm, while the gate insulating film 103 of each of the MOS transistors Qo of the peripheral circuit has a thickness of larger than 2.6 nm, normally in the range of about 2.6 to about 7.0 nm.

Furthermore, with respect to the antenna ratios (A/R) of the individual surface areas of the gate electrodes 104 of the minute MOS transistors Qi of the internal circuit 2, and the poly antennas which are electrically connected to the gate electrodes 104, the contact antennas, the via antennas and the wiring antennas (the surface area shown in this case means the surface area of all of the polysilicon antennas electrically connected to a certain gate electrode 104, the surface area of all of the contact antennas, the surface area of all of the via antennas, and the surface area of all of the wiring antennas. Then, if FIG. 2 is given as an example, the area of the poly antenna means the area of polysilicon other than the portion over the diffusion layer (i.e., of the portion over the isolation region), and the wiring area means the sum of the surface areas of the first upper layer wiring 131 and the second upper layer wiring 132 which are electrically connected to the same gate electrode. Also, this is applied to the case of the multilayer, and the via antenna is also similar to the wiring antenna) to the area of the gate insulating films 103, the poly antenna ratio is set to the range of 100 to infinity, the contact antenna ratio is set to the range of 10 to infinity, the via antenna ratio is set to the range of 20 to infinity, and the wiring antenna ratio is set to the range of 5,000 to infinity. Thus, the antenna standard is substantially relaxed to non-restriction. On the other hand, with respect to the antenna ratios of the individual surface areas of the gate electrodes 103, the contact plugs 121, the first via holes 122, the first and second upper layer wirings 131 and 132, and the aluminum pads 133 of the MOS transistors Qo of the peripheral circuit 3 to the gate insulating films 103, the poly antenna ratio is set equal to or smaller than 100, the contact antenna ratio is set equal to or smaller than 10, the via antenna ratio is equal to or smaller than 20, and the wiring antenna ratio is set equal to or smaller than 5,000. Thus, the antenna standard is severely set as compared with the former.

As a result, in the design of the peripheral circuit 3, since with respect to the antenna ratios, the poly antenna ratio is equal to or smaller than 100, the contact antenna ratio is equal to or smaller than 10, the via antenna ratio is equal to or smaller than 20, and the wiring antenna ratio is equal to or smaller than 5,000, the peripheral circuit 3 of the semiconductor device of the present invention suffers the restriction for the antenna standard similar to that for the conventional semiconductor devices. However, in the design of the internal circuit 2, with respect to the antenna ratios, the poly antenna ratio is larger than 100, the contact antenna ratio is larger than 10, the via antenna ratio is larger than 20, and the wiring antenna ratio is larger than 5,000. Thus, since these antenna ratios are substantially infinite and hence the antenna standard is relaxed for the peripheral circuit 3, the degree of freedom of the design of the internal circuit 2 is increased. Thus, since there is no need for performing design correction such as change of the distribution of the upper layer wiring to the upper layer or the lower layer for the positions of the violation of the antenna standard generated in the initial design as in the prior art, the design becomes easy. In particular, after the design of the peripheral circuit for which the severe antenna standard is set is preferentially carried out, the design of the internal circuit for which the more generous antenna standard is set is carried out, which leads to that the design meeting the antenna standard of the peripheral circuit can be readily carried out and also the antenna standard of the internal circuit can be readily met. This becomes advantageous in that the degradation of reliability of the gate insulating films, the degradation of characteristics of the gate insulating films, or the breakdown of the gate insulating films in the MOS transistors of the peripheral circuit and the internal circuit of the manufactured semiconductor device is prevented to enhance the conforming article rate and also the promotion of high integration, high speed, and the like in the semiconductor device is realized.

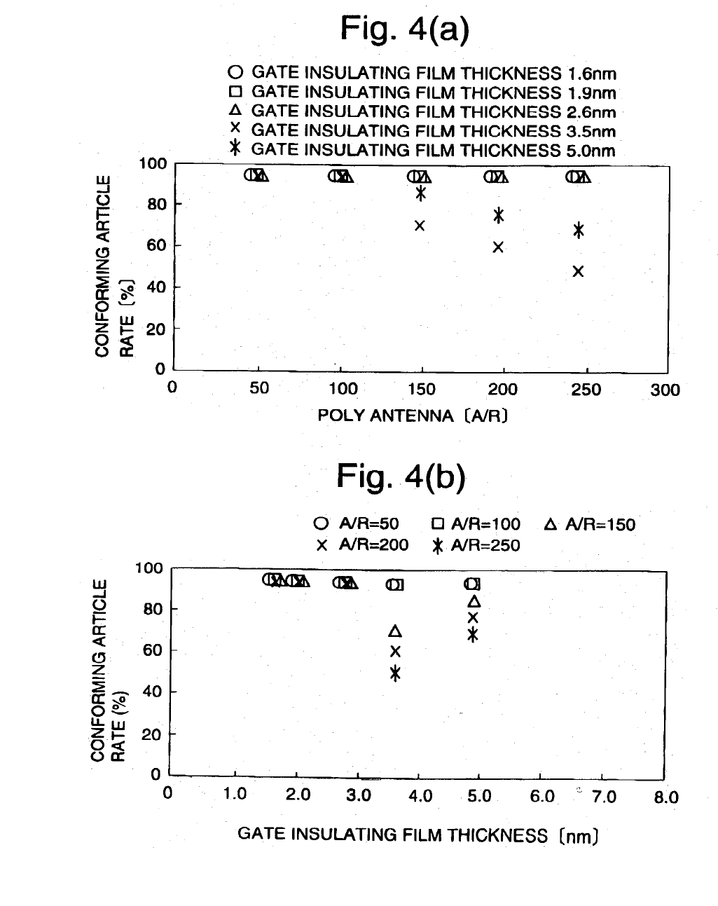

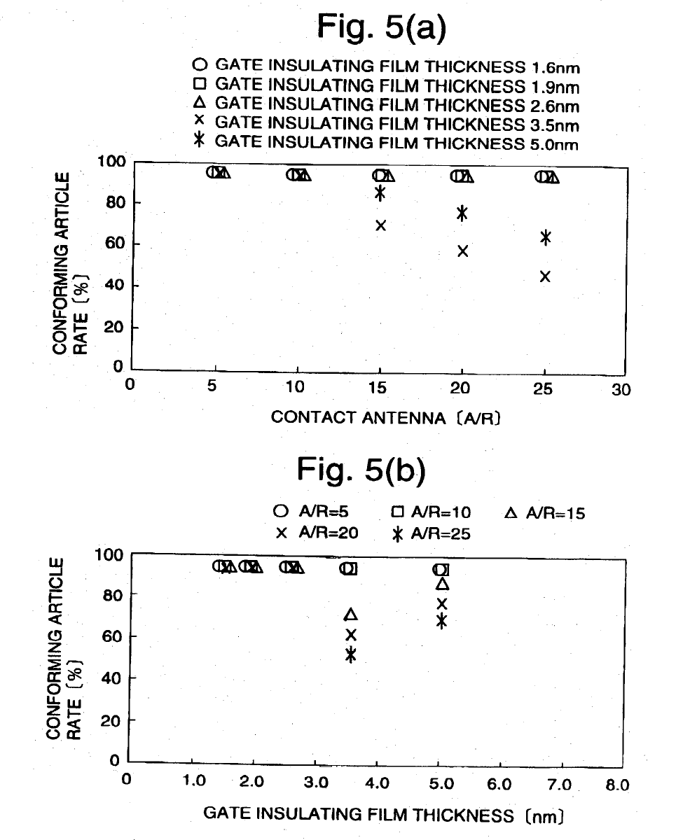

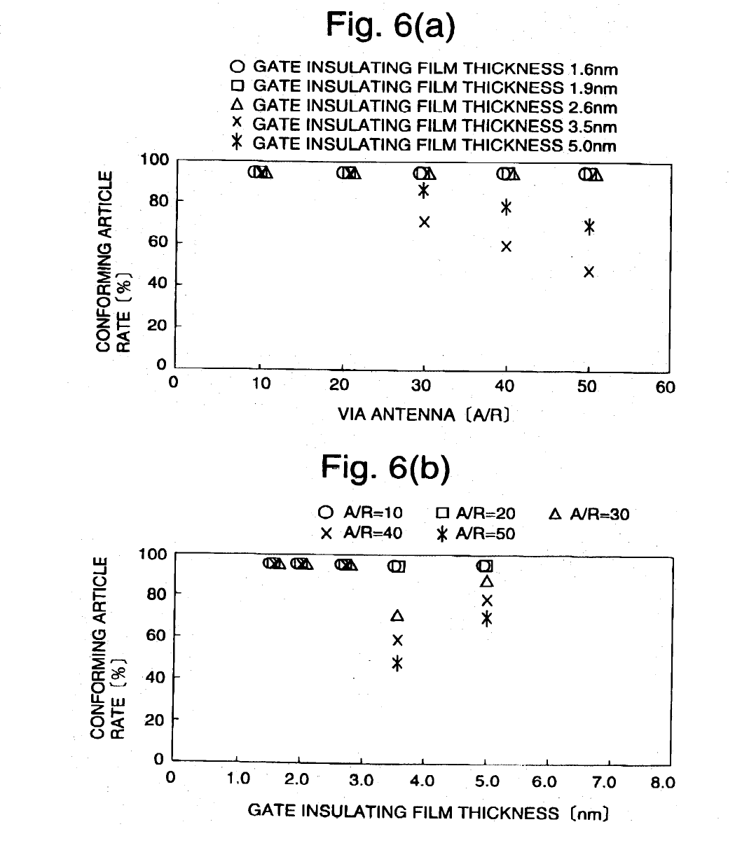

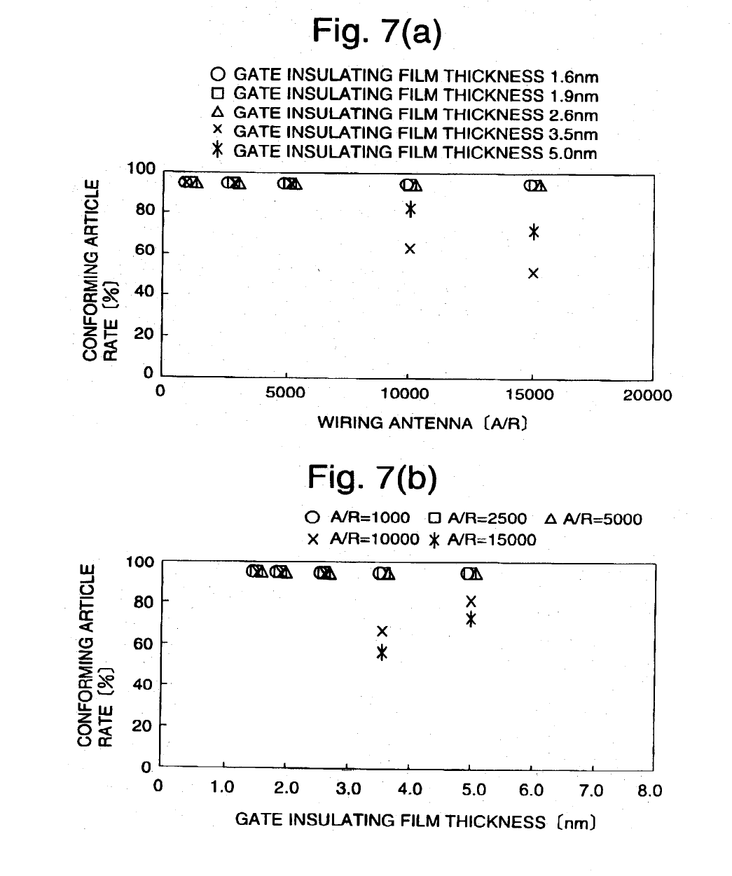

FIGS. 4(a) to 7(b) are respectively graphical representations showing the data which was obtained through the measurement made by the present inventor, i.e., the data which was obtained by measuring the conforming article rates in the semiconductor devices for which the circuit design and the manufacture were carried out in such a way that with respect to the poly antenna, the contact antenna, the via antenna, and the wiring antenna, the different antenna ratios are obtained for the MOS transistors having the different gate insulating film thicknesses. In this case, there were measured the conforming article rates in the case where the antenna ratios of the poly antenna, the contact antenna, the via antenna, and the wiring antenna were respectively changed with respect to the MOS transistors having the gate insulating films with thicknesses of 1.6 nm, 1.9 nm, 2.6 nm, 3.5 nm and 5.0 nm. The conforming article rate in this example means the rate of the MOS transistors in each of which the degradation of reliability of the gate insulating films, the degradation of characteristics of the gate insulating films, or the breakdown of the gate insulating films was not caused. For the degradation of reliability of the gate insulating films, the degradation of characteristics of the gate insulating films, or the breakdown of the gate insulating films, the judgement was carried out on the basis of the measurement of the gate leakage current when a predetermined voltage was applied to the gate electrode. From FIGS. 4(a), 5(a), 6(a) and 7(a), it is understood that when the thickness of the gate insulating film is equal to or smaller than 2.6 nm, the conforming article rate of about 100% can be obtained irrespective of the antenna ratio. Also, it is understood that when the thickness of the gate insulating film is larger than 2.6 nm, the conforming article ratio is decreased along with the increase in antenna ratio. In addition, from FIGS. 4(b), 5(b), 6(b) and 7(b), it is understood that even when the thickness of the gate insulating film is set to 5.0 nm, the design is carried out in such a way that the poly antenna ratio becomes equal to or smaller than 100, the contact antenna ratio becomes equal to or smaller than 10, the via antenna ratio becomes equal to or smaller than 20, and the wiring antenna ratio becomes equal to or smaller than 5,000, thereby being able to obtain the conforming article ratio of about 100%. From the foregoing, it is understood that thinning the gate insulating film makes it possible to enhance the conforming article rate even when the individual antenna ratios are increased, and also limitation of the individual antenna ratios makes it possible to enhance the conforming article rate even when the gate insulating film is thickened.

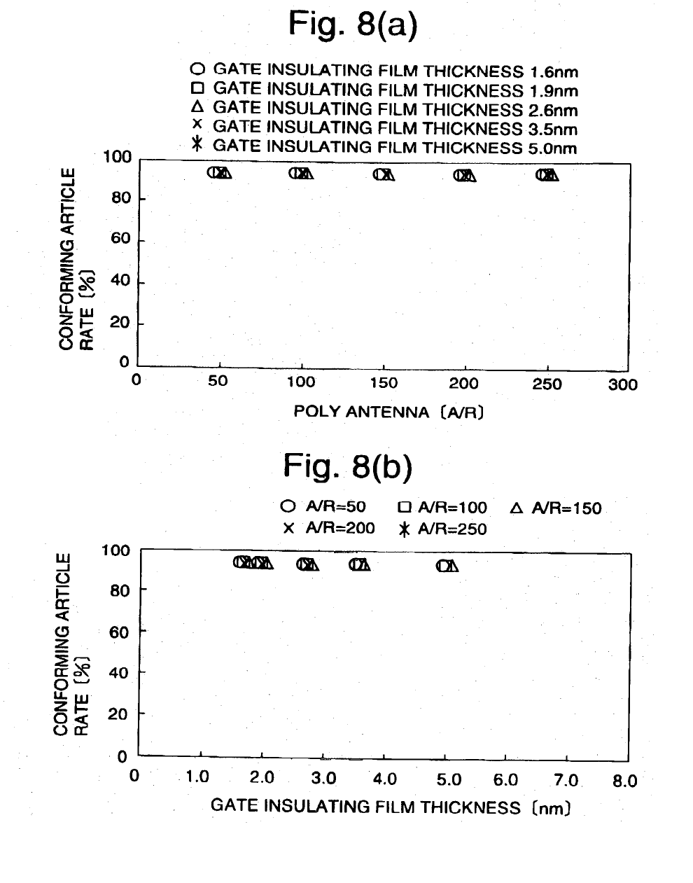

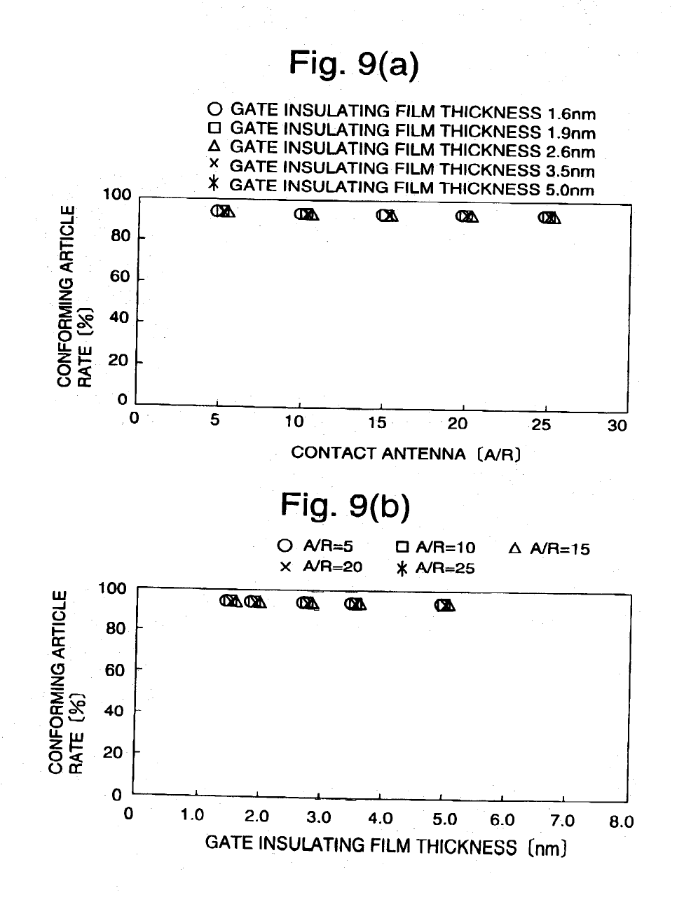

In addition, FIGS. 8(a) to 11(b) are respectively graphical representations showing the data which was obtained through the measurement made by the present inventor, i.e., the data which was obtained by measuring the conforming article rates in the semiconductor devices for which the circuit design and the manufacture were carried out in such a way that with respect to the NMOS transistors, the different antenna ratios are obtained for the NMOS transistors having the different gate insulating film thicknesses. In this case, there were measured the conforming article rates in the case where the antenna ratios were respectively changed similarly to the foregoing with respect to the NMOS transistors having the gate insulating films with thicknesses of 1.6 nm, 1.9 nm, 2.6 nm, 3.5 nm and 5.0 nm. The conforming article rate in this case means the rate of the NMOS transistors in each of which the degradation of reliability of the gate insulating films, the degradation of characteristics of the gate insulating films, or the breakdown of the gate insulating films was not caused. For the degradation of reliability of the gate insulating films, the degradation of characteristics of the gate insulating films, or the breakdown of the gate insulating films, the judgement was carried out on the basis of the measurement of the gate leakage current when a predetermined voltage was applied to the gate electrode. From FIGS. 8(a), 9(a), 10(a) and 11(a), it is understood that the conforming article rate of 100% can be obtained irrespective of the thickness of the gate insulating film, and the antenna ratio. Also, from FIGS. 8(b), 9(b), 10(b) and 11(b), it is understood that the conforming article rate of about 100% can be obtained irrespective of the thickness of the gate insulating film.

From this result, it is judged that when the thickness of the gate insulating film is set equal to or smaller than 2.6 nm, the tunneling of the electric charges becomes remarkable, and hence the electric charges charged in the antenna electrode are caused to flow into the semiconductor substrate without breaking down the gate insulating film due to the discharge. On the other hand, when the thickness of the gate insulating film is larger than 2.6 nm, the tunneling of the electric charges becomes insufficient. Thus, the discharge breakdown of the gate insulating film becomes easy to be caused by the electric charges charged in the antenna electrode and hence it becomes necessary to limit the antenna ratio.

Consequently, since in order to ensure about 100% as the conforming article rate in the above-mentioned embodiment, the thickness of the gate insulating film of each of the minute MOS transistors of the internal circuit is set equal to or smaller than 2.6 nm, the antenna standard can be relaxed in such a way that the poly antenna ratio becomes 250, the contact antenna ratio becomes 25, the via antenna ratio becomes 50, and the wiring antenna ratio becomes 15,000. In addition, since the thickness of the gate insulating film of each of the MOS transistors of the peripheral circuit is set to about 5.0 nm, the antenna standard has to be set in such a way that the poly antenna ratio becomes equal to or smaller than 100, the contact antenna ratio becomes equal to or smaller than 10, the via antenna ratio becomes equal to or smaller than 20, and the wiring antenna ratio becomes equal to or smaller than 5,000.

Note that, if the gate insulating film is thinned, then it is possible to further increase the antenna ratio. For example, when the thickness is 1.9 nm or 1.6 nm, it is supposed that even when the antenna ratio is increased up to equal to or larger than 20,000, or further up to infinity, the conforming article rate is made near 100%.

However, since there is the possibility that thinning the gate insulating film increases the gate leakage current, which becomes, in particular, disadvantageous in power consumption, it is desirable that the thickness of the gate insulating film is set to the desirable value in correspondence to the voltage applied to the gate electrode.

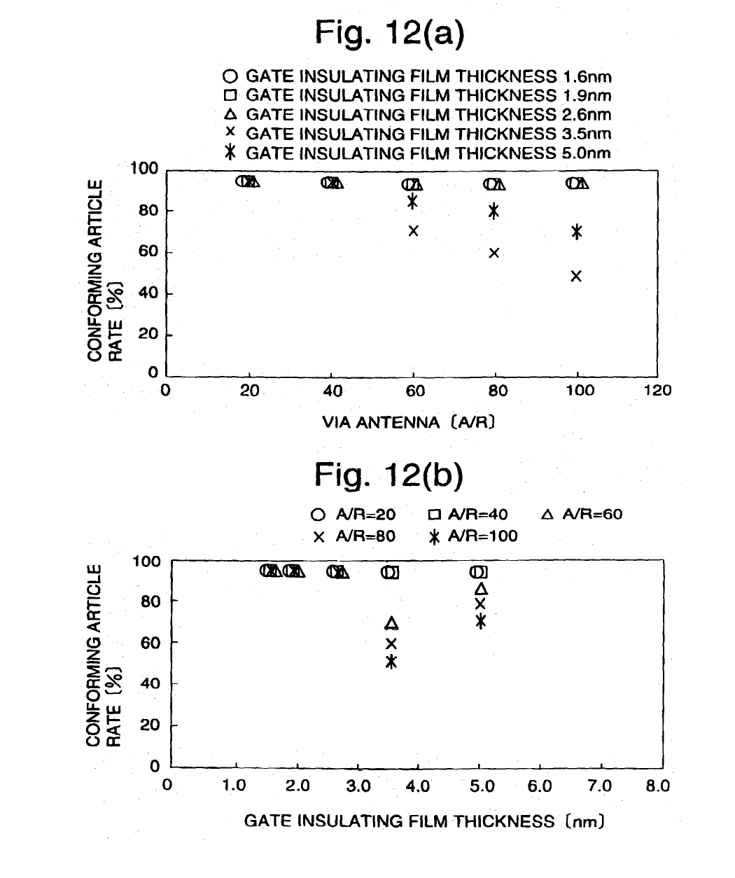

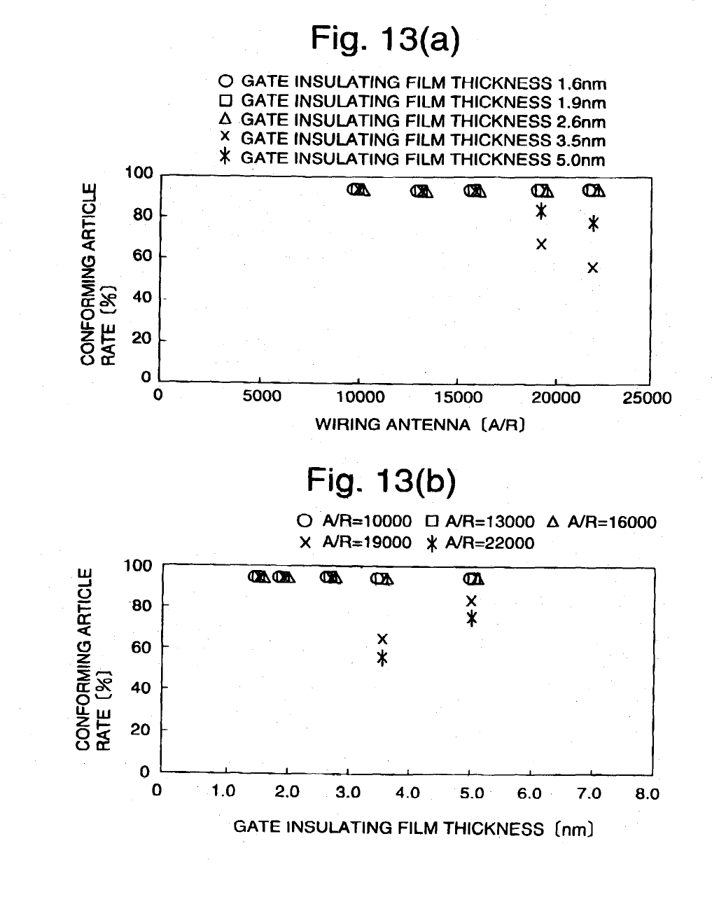

FIGS. 12(a), 12(b), 13(a) and 13(b) are respectively graphical representations showing the data which was obtained through the measurement made by the present inventor, i.e., the data which was obtained by measuring the conforming article rates in the semiconductor devices for which the circuit design and the manufacture were carried out in such a way that with respect to the PMOS transistors, the different antenna ratios can be obtained for the different gate insulating film thicknesses. In this case, the measurement was carried out with respect to the conforming article rates when the diode connection was made for the PMOS transistors having the gate insulating films with thicknesses of 1.6 nm, 1.9 nm, 2.6 nm, 3.5 nm and 5.0 nm similarly to the foregoing to change the individual antenna ratios. The conforming article rate in this case means the rate of the PMOS transistors in each of which the degradation of reliability of the gate insulating films, the degradation of characteristics of the gate insulating films, or the breakdown of the gate insulating films is not caused. The degradation of reliability of the gate insulating films, the degradation of characteristics of the gate insulating films, or the breakdown of the gate insulating films was judged on the basis of the measurement of the gate leakage current when a predetermined voltage was applied to the gate electrode. From FIGS. 12(a) and 13(a), it is understood that when the thickness of the gate insulating film is equal to or smaller than 2.6 nm, the conforming article rate of about 100% can be obtained irrespective of the antenna ratio. Also, it is understood that when the thickness of the gate insulating film is larger than 2.6 nm, the conforming article rate is decreased along with the increase in antenna ratio. In addition, from FIGS. 12(b) and 13(b), it is understood that even when the thickness of the gate insulating film is set to 5.0 nm, the conforming article rate of about 100% can be obtained by designing the PMOS transistors in such a way that the via antenna ratio becomes equal to or smaller than 40, and the wiring antenna ratio becomes equal to or smaller than 16,000.

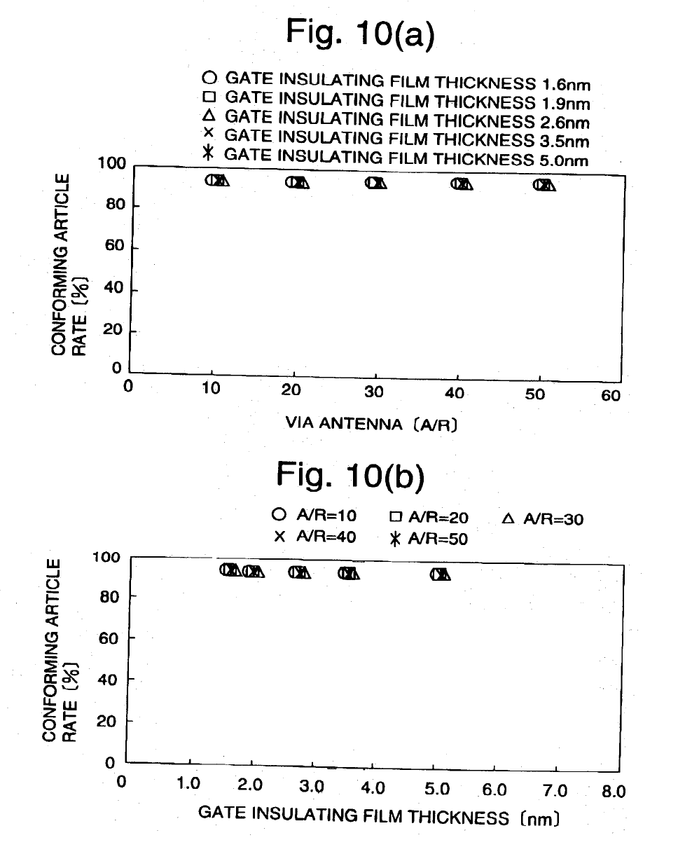

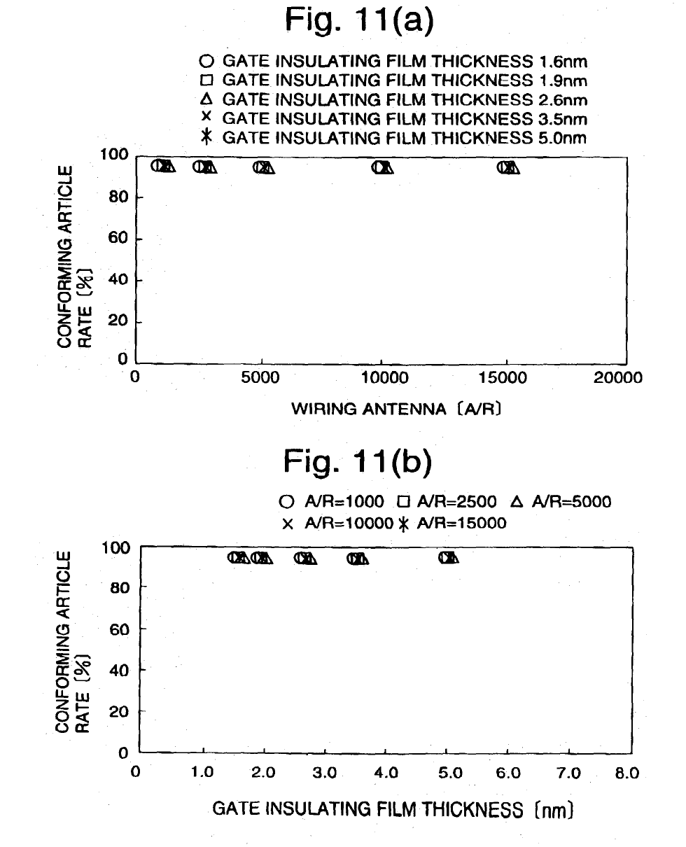

Thus, it is understood that from the result of comparison of the NMOS transistors of FIGS. 10(a), 10(b), 11(a) and 11(b) with the PMOS transistors of FIGS. 12(a), 12(b), 13(a) and 13(b), if after it is judged whether the transistor having the antenna electrode connected thereto is the NMOS transistor or the PMOS transistor, the transistor concerned is judged to be the NMOS transistor, then the standard can be further relaxed. Note that, the difference in charge-up between the NMOS transistor and the PMOS transistor is as we had mentioned above.

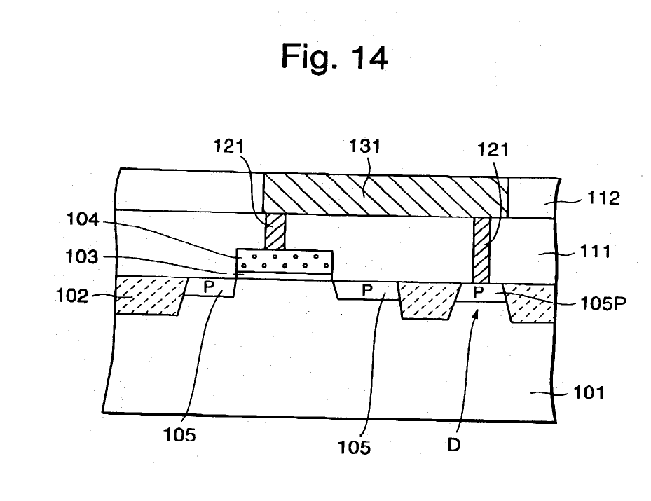

FIG. 14 is a cross sectional view showing the structure of an example in which for a PMOS transistor, a diode is connected. In the figure, a P type source/drain region 105 is formed within an N type silicon substrate or an N type well region 101 obtained through partition with an isolation insulating film 102, and a gate insulating film 103 and a gate electrode 104 are formed thereon. In addition, a P type region 105P is formed in another region obtained through partition with the isolation insulating film 102 concurrently with the formation of the source/drain region 105, and thus a PN junction type diode D is formed between the P type region 105P and the N type silicon substrate or the N type well region 101. Then, contact plugs 121 are formed through a first interlayer insulating film 111 so as to be electrically connected to the gate electrode 104 and a P type region 105P, respectively, and these contact plugs 121 are connected to each other through a first upper layer wiring 131. As a result, on and after the process for forming the first wiring 131, the positive electric charges charged in the antennas can be let free from the contact plugs 121 to the P type region 105 ox the N type silicon substrate or the N type well region 101, i.e., to the substrate side through the diode D. Here, in this specification, the area of the diode D is defined as the plane area of the diffusion layer just under the contact plug 121. Note that the effect offered by the diode connection is available for both of the via antennas and the wiring antennas, but can not be used for the poly antennas and the contact antennas because that effect can not be shown as long as the connection to the P type region 105P and the contact plug 121 which are formed concurrently with the formation of the source/drain region 105 or in the different process is not completed when the diode is to be connected. In addition, while the illustration is omitted here, this is also applied to the NMOS transistor.

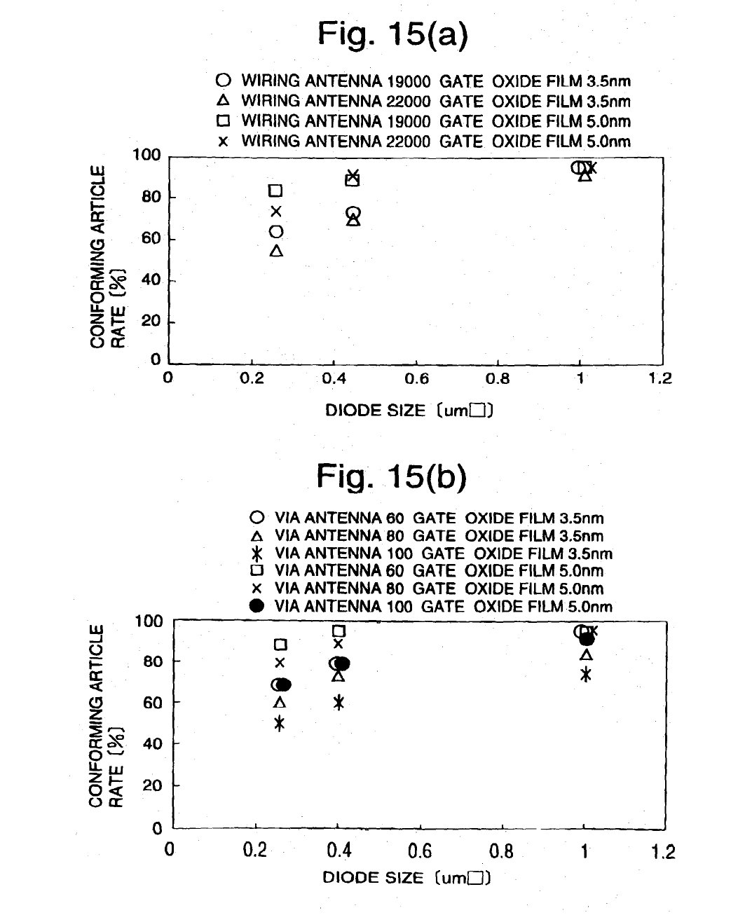

FIGS. 15(a) and 15(b) are respectively graphical representations showing the conforming article rates of the wiring antennas and the via antennas depending on the diode area. From this, it is understood that while the conforming article rate can be further enhanced as the antenna ratio is smaller, if in addition thereto, the diode area, i.e., the plane area of the diffusion layer just under the contact plug 121 is set equal to or larger than 0.4 m, then the individual conforming article rates can be made near about 100%. In such a manner, it is understood that the diode connection makes large the design upper limit of the various antenna ratios except for the poly antenna ratio and the contact antenna ratio and thus the antenna connection allows the antenna standard to be relaxed.

In addition, in the case of the above-mentioned embodiment, when the upper wiring portions which are to be commonly connected to the internal circuit 2 and the peripheral circuit 3 are designed, it is important that the commonly connected upper layer wiring portions must be made obedient to the generous antenna standard for the peripheral circuit since there is the possibility that the electric charges charged in those upper layer wiring portions are transmitted to the gate electrodes of both of the MOS transistors of the internal circuit and the peripheral circuit to break down particularly the gate insulating films of the MOS transistors of the peripheral circuit which is obedient to the generous antenna standard.

Here, while in the above-mentioned embodiment, the description has been given with respect to the semiconductor device which is mixedly loaded with the internal circuit and the peripheral circuit, the present invention is not intended to be limited to the semiconductor device having such a circuit configuration. That is to say, the present invention can be similarly applied to any one of semiconductor devices as long as it is such that two MOS transistors having gate insulating films which are different in thickness are formed on the same semiconductor device. Thus, in the case where MOS transistors having gate insulating films which are different in thickness are present even in the same internal circuit, the independent antenna standards may be set to the MOS transistors, respectively.

In addition, the present invention is not intended to be limited to the two MOS transistors having gate insulating films different in thickness, and hence even in the case of the semiconductor device including three or more MOS transistors having gate insulating films which are different in thickness, the antenna standards may be set in correspondence to the thicknesses of the gate insulating films of the MOS transistors in order to carry out the design thereof. This leads to that it is possible to prevent the degradation of reliability of the gate insulating films, the degradation of characteristics of the gate insulating films or the breakdown of the gate insulating films in the MOS transistors for which it is required to limit the antenna ratios to small values, while the degree of freedom of the design of the MOS transistor which can be designed in such a way that the antenna ratios become large can be enhanced, the design of the whole semiconductor device can be readily carried out and also the conforming article rates thereof can be enhanced.

In addition, while in the above-mentioned embodiment, there has been shown the example of the MOS transistor having the gate insulating film made of a silicon oxide film, a MOS transistor having a gate insulating film made of a silicon nitride film, a MOS transistor having a gate insulating film constituted by multilayer structure of a silicon oxide film and a silicon nitride film, or a MOS transistor having a gate insulating film made of a Ta₂O₅ insulating film, an HfO₂ insulating film, or the like other than the above-mentioned insulating films may also be available, and hence the present invention is not intended to be limited to use the above-mentioned kinds of insulating films. With respect to the MOS transistors each having any one of insulating films other than a silicon oxide film as the gate insulating film, the thickness of a limit allowing the tunneling in each of the insulating films to become remarkable is measured and the antenna standards for the MOS transistors each having the gate insulating film with a thickness equal to or smaller than the thickness concerned are relaxed, thereby being able to enhance the degree of freedom of the design of the semiconductor device including the MOS transistors concerned to allow the design thereof to be readily carried out.

Furthermore, in the semiconductor device of the present invention, it is to be understood that the substrate used therein is not intended to be limited to a P type silicon substrate, an N type silicon substrate, an SOI substrate, or the like, and also the isolation method used therein is not intended to be limited to lie LOCOS structure, the STI structure, or the like. Moreover, it is to be understood that for the material used for the gate electrode, aluminum, polysilicon, silicon germanium, or the like may also be used

As set forth herein above, according to the present invention, in a semiconductor device including a plurality of semiconductor elements having gate insulating films which are different in thickness, the different antenna standards are set for the semiconductor elements in such a way that the antenna standard for the semiconductor element having the gate insulating film with a thickness which is equal to or smaller than a predetermined thickness is made more generous than that for the semiconductor element having the gate insulating film with a thickness which is larger than the predetermined thickness. In particular, the antenna standard for the semiconductor element having the gate insulating film with a thickness which is equal to or smaller than a thickness allowing the tunneling of the electric charges to occur is made more generous than that for the semiconductor element having the gate insulating film with a thickness which is larger than that thickness, which makes it possible to increase the antenna ratio for the semiconductor element concerned to relax the design standard to thereby enhance the degree of freedom of the design and the manufacture of the semiconductor device. In addition, according to the present invention, the different antenna standards are respectively set for an NMOS semiconductor element and a PMOS semiconductor element, and also the different antenna standards are respectively set for a semiconductor element having a diode connected thereto and a semiconductor element having no diode connected thereto, which makes it possible similarly to enhance the degree of freedom of the design and the manufacture of the semiconductor device.

In addition, a method of manufacturing a semiconductor device according to the present invention includes the steps of: manufacturing a semiconductor element having a gate insulating film with a thickness which is larger than a predetermined thickness in accordance with a first antenna standard; and manufacturing a semiconductor element having a gate insulating film with a thickness which is smaller than the predetermined thickness in accordance with a second antenna standard which is relaxed as compared with the first antenna standard. Thus, at least a part of semiconductor elements of a semiconductor device can be designed and manufactured in accordance with the generous second antenna standard, which makes it possible to enhance the degree of freedom of the design and the manufacture of the whole semiconductor device and also to manufacture the semiconductor device with high conforming article rate. In addition, an NMOS semiconductor element and a PMOS semiconductor element are designed and manufactured in accordance with different antenna standards, respectively, and also a semiconductor element having a diode connected thereto and a semiconductor element having no diode connected thereto are designed and manufactured in accordance with different antenna standards, respectively, thereby being able to offer the same effects.

While the present invention has been particularly shown and described with reference to the preferred embodiments and the specified changes thereof, it will be understood that the various modifications and other changes will occur to those skilled in the art without departing from the scope and spirit of the invention. The scope of the invention is, therefore, to be determined solely by the appended claims.

What is claimed is:

1. A method of designing a semiconductor device including a plurality of semiconductor elements having gate insulating films which are different in thickness, where in different antenna standards are respectively applied to the plurality of semiconductor elements.

2. The method as claimed in claim 1, wherein a first antenna standard for a first semiconductor element having the gate insulating film with a thickness which is equal to or smaller than a predetermined thickness is relaxed as compared with a second antenna standard for a second semiconductor element having the gate insulating film with a thickness which is larger than the predetermined thickness.

3. The method as claimed in claim 2, wherein said predetermined thickness allowing the tunneling of the electric charges to occur.

4. The method as claimed in claim 3, wherein said gate insulating film is made of a silicon oxide film; and said predetermined thickness is about 2.6 nm.

5. The method as claimed in claim 3, wherein said second antenna standard is that a poly antenna ratio is equal to or smaller than 100, a contact antenna ratio is equal to or smaller than 10, a via antenna ratio is equal to or smaller than 20, and a wiring antenna ratio is equal to or smaller than 5,000.

6. The method as claimed in claim 5, wherein an antenna electrode which is used in common to said first and second semiconductor elements is formed in accordance with said second antenna standard.

7. A method of forming a semiconductor device on one semiconductor chip, comprising:
forming a first MOS transistor having a first gate insulating films of a first thickness with a first antenna standard; and
forming a second MOS transistor having a second gate insulating film of a second thickness which is thicker than said first thickness with a second antenna standard which is relaxed as compared with said first antenna standard.

8. The method as claimed in claim 7, wherein:
said first thickness is a thickness allowing a tunnel current therethrough and said second thickness is a thickness not allowing the tunnel current therethrough.

9. The method as claimed in claim 8, wherein:
said first MOS transistor is formed in an internal circuit and said second MOS transistor is formed in a peripheral circuit.

10. The method as claimed in claim 7, wherein:
said first MOS transistor is a NMOS transistor and said second MOS transistor is a PMOS transistor.

11. The method as claimed in claim 9, wherein, said first thickness is equal to or smaller than 2.6 nm and said second thickness is larger than 2.6 nm.

12. The method as clamed in claim 7, wherein:
said first MOS transistor has a diode connected between a gate electrode thereof and a substrate and said second MOS transistor has no diode connected between a gate electrode thereof and a substrate.

13. The method as claimed in claim 8, wherein:
said first standard is that a poly antenna ratio is larger than a first value and said second standard is that the poly antenna ratio is equal to or smaller than the first value.

14. The method as claimed in claim 8, wherein:
said first standard is that a contact antenna ratio is larger than a first value and said second standard is that the contact antenna ratio is equal to or smaller than the first value.

15. The method as claimed in claim 8, wherein:
said first standard is that a via antenna ratio is larger than a first value and said second standard is that the via antenna ratio is equal to or smaller than the first value.

16. The method as claimed in claim 8, wherein:
said first standard is that a wiring antenna ratio is larger than a first value and said second standard is that the wiring antenna ratio is equal to or smaller than the first value.

17. A method of forming a semiconductor device on one semiconductor chip, comprising:
forming a first MOS transistor having a first gate insulating film which allows a tunnel current therethrough with a first antenna standard;
forming a second MOS transistor having a second gate insulating film which does not allow a tunnel current therethrough with a second antenna standard which is different form said first antenna standard.

18. The method as claimed in claim 17, wherein said first antenna standard is relaxed compared with said second antenna standard.

19. The method as claimed in claim 18, wherein
said first antenna standard is that a poly antenna ratio is larger than a first value, a contact antenna ratio is larger than a second value, a via antenna ratio is larger than a third value and a wiring antenna ratio is larger than a fourth value;
said second antenna standard is that a poly antenna ratio is equal to or smaller than the first value, the contact antenna ratio is equal to or smaller than the second value, the via antenna ratio is equal to or smaller than the third value and the wiring antenna ratio is equal to or smaller than the fourth value.
